(19) United States
(12) Patent Application Publication
(10) Pub. No.: US 2012/0254816 A1
(43) Pub. Date: Oct. 4, 2012

(54) NOISE REDUCTION USING FEEDBACK TO A WIRE SPREADER ROUTER

(75) Inventors: RICHARD S. BRINK, ROCHESTER, MN (US); MICHAEL R. CURRY, ROCHESTER, MN (US); DONALD R. FEARN, ROCHESTER, MN (US); MICHAEL D. MAURICE, AUSTIN, TX (US); THOMAS C. PEREZ, AUSTIN, TX (US); SCOTT TRCKA, ROCHESTER, MN (US); JOHN W. ZACK, ROCHESTER, MN (US)

(73) Assignee: INTERNATIONAL BUSINESS MACHINES CORPORATION, ARMONK, NY (US)

(21) Appl. No.: 13/078,063

(22) Filed: Apr. 1, 2011

(51) Int. Cl. G06F 17/50

(52) U.S. Cl. 716/115

(57) ABSTRACT

A computer implemented method, system, and/or computer program product reduce noise in a circuit. A level of noise imposed by an aggressor line on a victim line is determined. The aggressor line and the victim line are an aggressor/victim line pair from multiple aggressor/victim line pairs in a circuit. Determination of the noise level is conducted during a predetermined window of time during which a signal is being transmitted along the aggressor line. Each of the multiple aggressor/victim line pairs are ranked according to a level of noise being imposed by each aggressor line on each victim line. The spacing between a highest ranked aggressor/victim line pair is then expanded.

### BACKGROUND

The present disclosure relates to the field of computers, and specifically to the use of computers in designing circuits. Still more particularly, the present disclosure relates to the use of computers in reducing noise between nets in a circuit through the use of wire spreading.

Noise between wires on a chip may be influenced by line to line capacitance, and/or inductance, and/or line impedance, in which an aggressor line imposes unwanted noise on a victim line. Such noise creates multiple problems, such as unexpected changes in timing patterns, increased voltages on lines (resulting in erroneous switching of connected transistors), etc. One way to avoid such noise is to spread lines apart. However, limited real estate in a circuit limits how many line pairs can be spread apart.

### BRIEF SUMMARY

A computer implemented method, system, and/or computer program product reduce noise in a circuit. A level of noise imposed by an aggressor line on a victim line is determined by signal integrity techniques. The aggressor line and the victim line are an aggressor/victim line pair from multiple aggressor/victim line pairs in a circuit. Determination of the noise level is conducted during a predetermined window of time during which a signal is being transmitted along the aggressor line. Each of the multiple aggressor/victim line pairs are ranked according to a level of noise being imposed by each aggressor line on each victim line. The spacing between a highest ranked aggressor/victim line pair is then expanded.

### BRIEF DESCRIPTION OF THE SEVERAL VIEWS OF THE DRAWINGS

FIG. 1 depicts an exemplary computer in which the present disclosure may be implemented;

FIG. 2 depicts two exemplary aggressor/victim line pairs with different circumstances on the victim lines;

FIG. 3 illustrates exemplary aggressor/victim line pairs in which noise is imposed from an aggressor line onto a victim line; and

FIG. 4 is a high level flow chart of one or more exemplary steps taken by a processor to minimize noise on lines in a circuit.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

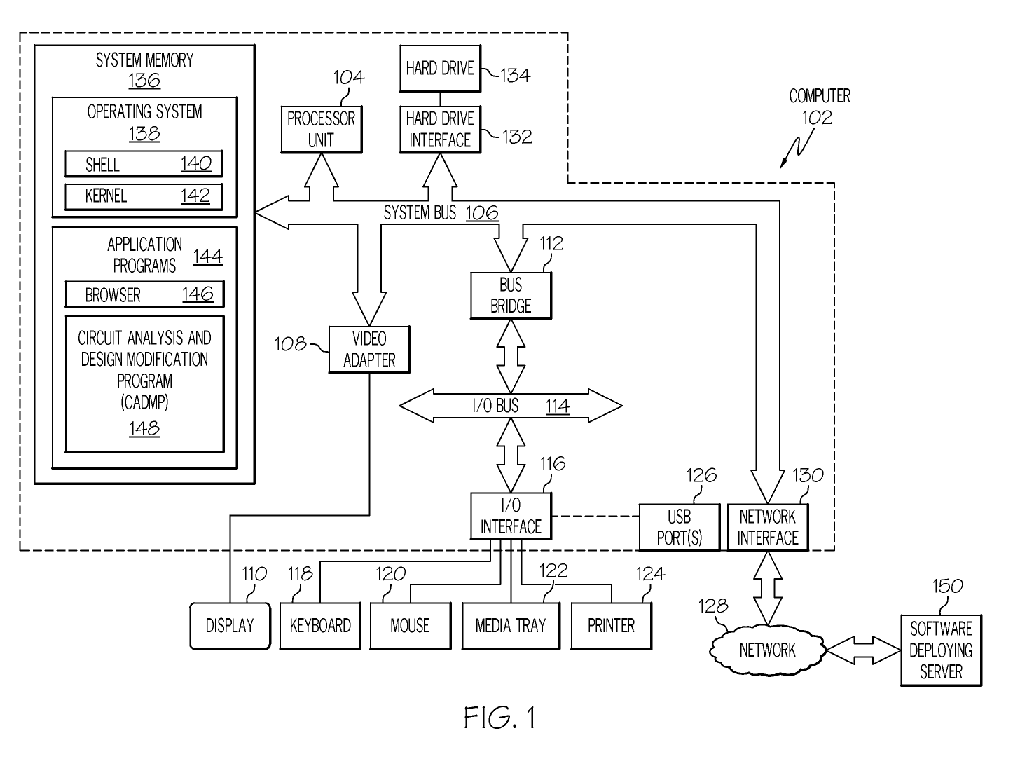

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150.

Computer 102 includes a processing unit 104 that is coupled to a system bus 106. Processing unit 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 using a network interface 130 to a network 128. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

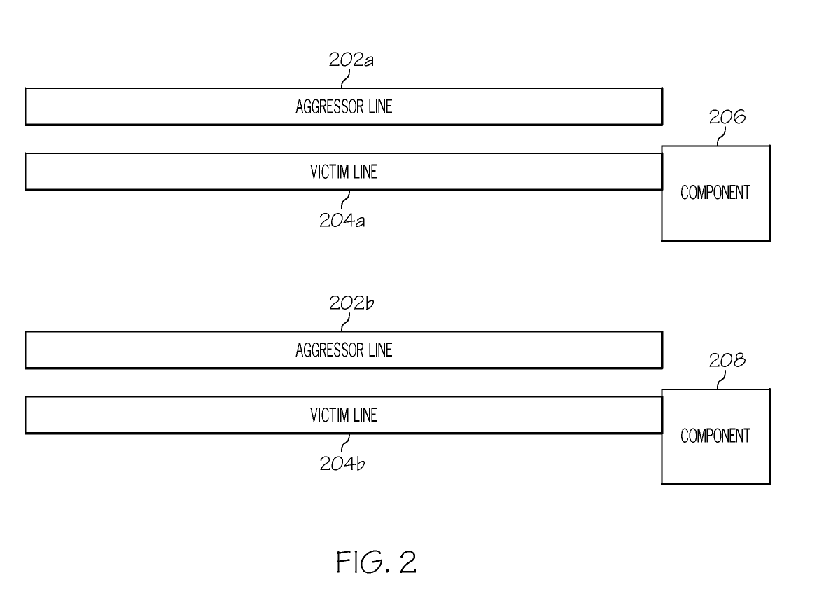

Application programs 144 in computer 102's system memory (as well as software deploying server 150's system memory) also include a Circuit Analysis and Design Modification Program (CADMP) 148. CADMP 148 includes code for implementing the processes described below, including those described in FIGS. 2-4. In one embodiment, computer 102 is able to download CADMP 148 from software deploying server 150, including in an on-demand basis, wherein the code in CADMP 148 is not downloaded until needed for execution to define and/or implement the improved enterprise architecture described herein. Note further that, in one embodiment of the present invention, software deploying server 150 performs all of the functions associated with the present invention (including execution of CADMP 148), thus freeing computer 102 from having to use its own internal computing resources to execute CADMP 148.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

Disclosed herein is a process for designing and modifying circuits in a way that minimizes unwanted noise on lines. In one embodiment, this noise is caused by line capacitance, which results from an aggressor line imposing noise on a nearby victim line when electronic signals pass along the aggressor line. In accordance with one embodiment of the present disclosure, the coupled noise being addressed is only noise that falls within a timing window. That is, assume that the victim line is part of a circuit. Thus, in a first scenario, assume further that a signal passing along the aggressor line causes noise to be imposed on the victim line during some window of time, but noise on the victim line within that window of time is inconsequential to the overall functionality of the circuit in which the victim line resides. In this case, imposed noise does not need to be resolved. In a second scenario, however, assume that imposing noise on the victim line during this window of time will cause problems to the circuit on which the victim line resides. The present disclosure describes how to address this issue found in the second scenario. In one embodiment, the process described herein is implemented in a wire spreader/router, such as logic and software shown in computer 102 as depicted in FIG. 1.

With reference then to FIG. 2, consider a set of lines in which line interference, such as that caused by line capacitance between two lines, is occurring during some predefined window of time. For example, assume that aggressor line 202a is imposing noise on victim line 204a, which is connected to component 206. Component 206 may be a transistor, which is turned on or off according to the voltage on victim line 204a. Alternatively, component 206 may be a circuit that ultimately controls subcomponents, timing patterns, etc. Now assume that, during this predetermined window of time, it does not matter what component 206 does, no action taken by component 206 will be affected by imposed noise from aggressor line 202a. In this case, there is no need to address any line interference if signals on aggressor line 202a only occur when it does not matter what component 206 does or does not do.

However, consider the line pair of aggressor line 202b and victim line 204b, which is connected to component 208 (i.e., a transistor, a timing circuit, etc.). If noise on victim line 204b will adversely affect the operation of component 208 during the window of time that a signal is passing along aggressor line 202b, then this problem is addressed according to the present disclosure.

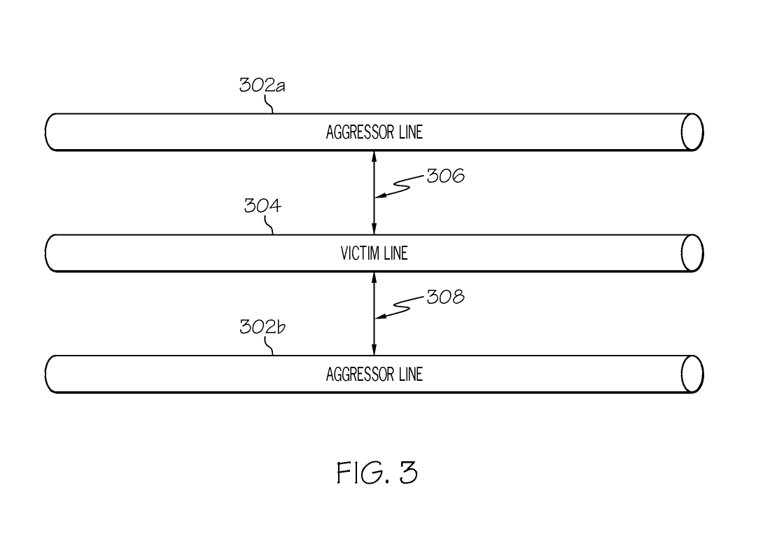

One solution to reduce line to line capacitance or inductance is to adjust the spacing between adjacent lines, either with or without shielding wires (i.e., grounded “dummy” wires that intercept line interference between an aggressor line and a victim line) between the adjacent lines. For example, consider aggressor line 302a and victim line 304 in FIG. 3. As a signal passes along aggressor line 302a, line to line capacitance imposes noise on the victim line 304, which needs to be “quiet” (no extraneous signal on the line) during some window of time. In order to reduce this line capacitance induced noise, spacing 306 can be expanded, such that victim line 304 is moved farther away from aggressor line 302a. However, this results in a second aggressor line 302b, which may also be passing a signal during that window of time, to be closer to the victim line 304, since the distance of spacing 308 now has been consequentially reduced. Thus, a second examination should be made in order to determine if the solution (spreading aggressor line 302a and victim line 304 farther apart) is worse than the initial problem, due to the increased level of line capacitance imposed onto the victim line 304 from the aggressor line 302b. As noted above, in one embodiment line capacitance between the aggressor line 302a and the victim line 304, and/or aggressor line 302b and the victim line 304, can be further reduced by laying shielding lines (not shown) between the aggressor/victim. These shielding lines are connected to a low-impedance noise-insensitive net such as a ground wire, and thus sacrificially take on some, if not all, of the noise being imposed on the victim line 304 by the aggressor line 302a/b.

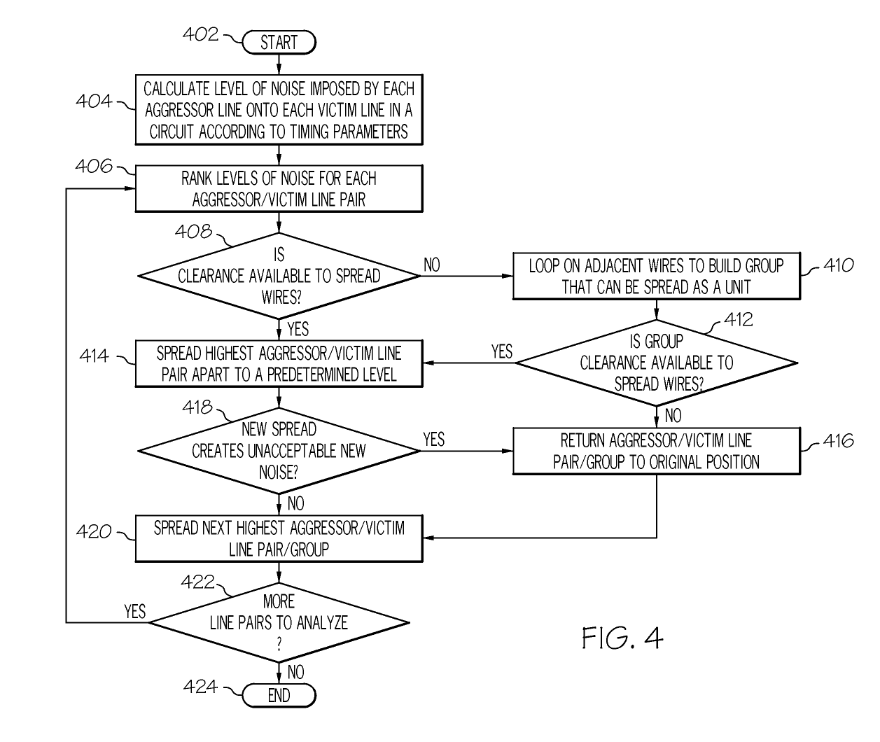

With reference now to FIG. 4, a high level flow chart of one or more exemplary steps taken by a processor to minimize noise on lines in a circuit is presented. After initiator block 402, which may be prompted by an initiation of a new circuit design process or a modification of an existing circuit design, a level of noise being imposed by each aggressor line onto one or more adjacent victim lines is calculated (block 404). In one embodiment, this calculation/prediction/measurement is performed during a predetermined window of time. In one embodiment, this predetermined window of time is a finite amount of time that is a portion of time during which operations are occurring on the aggressor line and/or victim lines. In one embodiment, the predetermined window of time is that window of time during which an effect of imposed noise on a victim line will be significant only when some predefined criteria (e.g., the noise will disrupt operation of a component attached to the victim line, the noise will disrupt timing of critical signals along the victim line, etc.) is met. Thus, in this embodiment, the processes described herein (i.e., ranking aggressor/victim line pairs) are directed to identifying/ranking such line pairs only for periods of time during which the effect of imposed noise on the victim line will be significant according to some predefined criteria. In one embodiment, however, this window of time is not a finite amount of time, as the timing window can be infinitely large when the aggressor line and the victim line are asynchronous to each other.

As described in block 406, each level of noise for each aggressor/victim line pair being evaluated is then ranked. This ranking is based on (1) the amount of noise being imposed and/or (2) the effect of the noise on the victim during some predefined window of time. Thus, in one embodiment the aggressor/victim line pair with the highest ranking will simply have the highest level of noise being imposed on the victim line at any time (as compared with other aggressor/victim line pairs being examined). In another embodiment, the aggressor/victim line pair with the highest ranking has the highest level of noise (compared to other aggressor/victim line pairs being examined) being imposed on the victim line only during a predefined window of time. In another embodiment, the aggressor/victim line pair with the highest ranking has the highest level of noise (compared to other aggressor/victim line pairs being examined) being imposed on the victim line at any time, and has a significant (according to some predefined criteria such as that described above for transistor/switch operation, timing patterns, etc.) impact on components attached to the victim line at any time. In another embodiment, the aggressor/victim line pair with the highest ranking has the highest level of noise (compared to other aggressor/victim line pairs being examined) being imposed on the victim line during a predetermined window of time, and has a significant (according to some predefined criteria such as that described above for transistor/switch operation, timing patterns, etc.) impact on components attached to the victim line only during that window of time. Note that in one embodiment, the level of noise and/or the above-described rankings are independent of the linear length of the wires that make up the aggressor/victim line pairs.

Once the highest ranked aggressor/victim pair is identified, a determination is made as to whether there is adequate clearance available to spread the pair apart (query block 408). If not, then one or both wires in the pair are looped on to adjacent wires in order to build a group that can be spread as a unit (block 410), assuming that there is adequate group clearance for this new grouping to spread out (query block 412). If there is adequate clearance/room, then the lines in the aggressor/victim pair are spread apart (either as the original aggressor/victim pair—from block 406, or as part of the new group—from blocks 410-412) until the noise being imposed drops below a predetermined acceptable level (block 414). In either scenario, spreading this aggressor/victim pair apart may require other adjacent nets to be moved in conjunction with the pair in order to create the needed clearance. If, however, this line spreading causes unacceptably high new noise on the victim line from another aggressor line (query block 418), then the spacing between the original aggressor line and the victim line is returned to the original level (block 416) along with any nets moved to create the needed clearance for a newly created group (if block 416 is reached via blocks 410-412). The process depicted in block 416 assumes that merely moving the original aggressor line and the victim line slightly closer, but not as close as they were originally, will not put the noise imposed on the victim line at an acceptable level. If such slight movement results in an acceptable level of noise on the victim line, then such movement is performed (instead of returning to the original positions).

As indicated by query block 422, the process continues in a reiterative manner (blocks 406 through 420) until each pair of aggressor/victim line pairs, which have been identified for examination/analysis, in a network/system have been examined, ranked, and adjusted accordingly. The process ends at terminator block 424.

Note that while the present disclosure has been described using line capacitance as a compelling reason to adjust spacing between wires/nets/lines, the process described herein is also applicable when used to address line impedance and/or inductance that causes noise to be imposed on a victim line by an aggressor line.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer implemented method of reducing noise in a circuit, the computer implemented method comprising:
a processor making a determination of a level of noise being imposed by an aggressor line on a victim line, and wherein said aggressor line and said victim line are an aggressor/victim line pair from multiple aggressor/victim line pairs in a circuit, and wherein said determination is made for a predetermined window of time in which a signal is being transmitted along said aggressor line;
the processor ranking each of said multiple aggressor/victim line pairs according to a level of noise being imposed by each aggressor line on each victim line; and
the processor expanding a spacing between lines in a highest ranked aggressor/victim line pair, wherein the highest ranked aggressor/victim line pair has a highest amount of noise being imposed by the aggressor line on the victim line as compared with other aggressor/victim line pairs in the circuit.

2. The computer implemented method of claim 1, further comprising:
in response to determining that expanding the spacing between the highest ranked aggressor/victim line pair creates, from another aggressor line, new noise that exceeds a predetermined level, repositioning the highest ranked aggressor/victim line pair back to an original configuration that existed before said expanding.

3. The computer implemented method of claim 1, further comprising:
the processor further ranking other aggressor/victim line pairs according to the level of noise being imposed by each aggressor line on a particular victim line.

4. The computer implemented method of claim 1, further comprising:
the processor establishing a predetermined impact level based on an effect that noise from the aggressor line has on a component that is attached to the victim line during the predetermined window of time; and
the processor further ranking each of said multiple aggressor/victim line pairs according to the predetermined impact level.

5. The computer implemented method of claim 1, further comprising:
the processor establishing a predetermined impact level based on an effect that noise from the aggressor line has on a component that is attached to the victim line at any time; and
the processor further ranking each of said multiple aggressor/victim line pairs according to the predetermined impact level.

6. The computer implemented method of claim 1, wherein the level of noise imposed within each of multiple aggressor/victim line pairs is caused by line capacitance between aggressor lines and victim lines within the multiple aggressor/victim line pairs.

7. The computer implemented method of claim 1, wherein the level of noise imposed within each of multiple aggressor/victim line pairs is caused by line inductance between aggressor lines and victim lines within the multiple aggressor/victim line pairs.

8. A computer program product for reducing noise in a circuit, the computer program product comprising:
a computer readable storage media;
first program instructions to make a determination of a level of noise being imposed by an aggressor line on a victim line, and wherein said aggressor line and said victim line are an aggressor/victim line pair from multiple aggressor/victim line pairs in a circuit, and wherein said determination is made for a predetermined window of time in which a signal is being transmitted along said aggressor line;
second program instructions to rank each of said multiple aggressor/victim line pairs according to a level of noise being imposed by each aggressor line on each victim line; and
third program instructions to expand a spacing between lines in a highest ranked aggressor/victim line pair, wherein the highest ranked aggressor/victim line pair has a highest amount of noise being imposed by the aggressor line on the victim line as compared with other aggressor/victim line pairs in the circuit; and wherein
the first, second, and third program instructions are stored on the computer readable storage media.

9. The computer program product of claim 8, further comprising:
fourth program instructions to, in response to determining that expanding the spacing between the highest ranked aggressor/victim line pair creates, from another aggressor line, new noise that exceeds a predetermined level, reposition the highest ranked aggressor/victim line pair back to an original configuration that existed before said expanding; and wherein
the fourth program instructions are stored on the computer readable storage media.

10. The computer program product of claim 8, further comprising:
fourth program instructions to further rank other aggressor/victim line pairs according to the level of noise being imposed by each aggressor line on a particular victim line; and wherein
the fourth program instructions are stored on the computer readable storage media.

11. The computer program product of claim 8, further comprising:
fourth program instructions to establish a predetermined impact level based on an effect that noise from the aggressor line has on a component that is attached to the victim line during the predetermined window of time; and
fifth program instructions to further rank each of said multiple aggressor/victim line pairs according to the predetermined impact level; and wherein
the fourth and fifth program instructions are stored on the computer readable storage media.

12. The computer program product of claim 8, further comprising:
fourth program instructions to establish a predetermined impact level based on an effect that noise from the aggressor line has on a component that is attached to the victim line at any time; and
fifth program instructions to further rank each of said multiple aggressor/victim line pairs according to the predetermined impact level; and wherein
the fourth and fifth program instructions are stored on the computer readable storage media.

13. The computer program product of claim 8, wherein the level of noise imposed within each of multiple aggressor/victim line pairs is caused by line capacitance between aggressor lines and victim lines within the multiple aggressor/victim line pairs.

14. A computer system comprising:
a central processing unit (CPU), a computer readable memory, and a computer readable storage device;
first program instructions to make a determination of a level of noise being imposed by an aggressor line on a victim line, and wherein said aggressor line and said victim line are an aggressor/victim line pair from multiple aggressor/victim line pairs in a circuit, and wherein said determination is made for a predetermined window of time in which a signal is being transmitted along said aggressor line;
second program instructions to rank each of said multiple aggressor/victim line pairs according to a level of noise being imposed by each aggressor line on each victim line; and
third program instructions to expand a spacing between lines in a highest ranked aggressor/victim line pair, wherein the highest ranked aggressor/victim line pair has a highest amount of noise being imposed by the aggressor line on the victim line as compared with other aggressor/victim line pairs in the circuit; and wherein
the first, second, and third program instructions are stored on the computer readable storage media for execution by the CPU via the computer readable memory.

15. The computer system of claim 14, further comprising:
fourth program instructions to, in response to determining that expanding the spacing between the highest ranked aggressor/victim line pair creates, from another aggressor line, new noise that exceeds a predetermined level, reposition the highest ranked aggressor/victim line pair back to an original configuration that existed before said expanding; and wherein
the fourth program instructions are stored on the computer readable storage media for execution by the CPU via the computer readable memory.

16. The computer system of claim 14, further comprising:
fourth program instructions to further rank other aggressor/victim line pairs according to the level of noise being imposed by each aggressor line on a victim line; and wherein
the fourth program instructions are stored on the computer readable storage media for execution by the CPU via the computer readable memory.

17. The computer system of claim 14, further comprising:
fourth program instructions to establish a predetermined impact level based on an effect that noise from the aggressor line has on a component that is attached to the victim line during the predetermined window of time; and
fifth program instructions to further rank each of said multiple aggressor/victim line pairs according to the predetermined impact level; and wherein
the fourth and fifth program instructions are stored on the computer readable storage media for execution by the CPU via the computer readable memory.

18. The computer system of claim 14, further comprising:
fourth program instructions to establish a predetermined impact level based on an effect that noise from the aggressor line has on a component that is attached to the victim line at any time; and
fifth program instructions to further rank each of said multiple aggressor/victim line pairs according to the predetermined impact level; and wherein
the fourth and fifth program instructions are stored on the computer readable storage media for execution by the CPU via the computer readable memory.

19. The computer system of claim 14, wherein the level of noise imposed within each of multiple aggressor/victim line pairs is caused by line capacitance between aggressor lines and victim lines within the multiple aggressor/victim line pairs.

20. The computer system of claim 14, wherein the level of noise imposed within each of multiple aggressor/victim line pairs is caused by line inductance between aggressor lines and victim lines within the multiple aggressor/victim line pairs.
